(19) United States
(12) Patent Application Publication
(10) Pub. No.: US 2007/0039805 A1
(43) Pub. Date: Feb. 22, 2007

(54) Slotted roller for low back pressure module

(76) Inventor: Sergio Fandella, Mogliano Veneto (IT)

Correspondence Address: HODGSON RUSS LLP, ONE M & T PLAZA, SUITE 2000, BUFFALO, NY, 14203-2391, US

(21) Appl. No.: 11/205,388

(22) Filed: Aug. 17, 2005

(51) Int. Cl. B65G 17/38; B65G 17/24

(52) U.S. Cl. 198/779; 198/853

(57) ABSTRACT

A low back pressure belt module for forming an endless belt for use with a conveyor. The modular conveyor belt is formed of rows of belt modules pivotally interlinked by transverse pivot rods. The belt modules have a plurality of first link ends disposed in the direction of belt travel and a plurality of second link ends disposed in the opposite direction. Transverse holes in the link ends are aligned to accommodate a pivot rod. When the link ends of the consecutive rows of side-by-side modules are intercalated, the pivot rod serves as a hinge pin in a hinged joint between consecutive interlinked rows. The low back pressure belt modules include shafts supported above the top surface of the module. The shafts carry a plurality of rollers to form a low back pressure conveying surface.

### FIELD OF THE INVENTION

This invention relates to conveyor belts and, more particularly, to modular plastic conveyor belts formed of rows of plastic belt modules pivotally interlinked by transverse pivot rods.

### BACKGROUND OF THE INVENTION

When transporting articles by means of a conveyor, there are many instances in which the articles will back up or accumulate on the conveyor. When articles accumulate, they push against each other building up back pressure. A large back pressure is unacceptable when the articles being carried by the conveyor are fragile because the force of the articles pushing against each other tends to damage them. The back pressure also puts an extra load on the conveyor and sprockets, causes sliding friction and abrasion of the conveyor, and results in higher energy consumption.

There have been solutions to the back pressure problems described above. U.S. Pat. No. 4,909,380 (“the '380 patent”) discloses a solution to backline pressure that includes shafts mounted above the top surface of belt modules. Each shaft carries a plurality of rollers forming a low back pressure conveying surface. The rollers are typically manufactured from a solid material. However, when products are stopped and accumulate on the rollers, the rollers tend to vibrate and create significant noise.

Accordingly, what is needed is a roller for a low back pressure chain that reduces the vibration and noise associated with the solid rollers.

### SUMMARY OF THE INVENTION

The present invention meets the above-described need by providing a low back pressure chain with slotted rollers that reduce the vibration and noise associated with previous rollers.

The chain is formed from a plurality of belt modules having a first plurality of link ends and a second plurality of link ends extending in opposite directions from an intermediate section. Shafts containing rollers are supported above the top surface of the module to provide a low back pressure conveying surface such that products are not damaged when articles back up or accumulate on the conveyor.

### BRIEF DESCRIPTION OF THE DRAWINGS

The invention is illustrated in the drawings in which like reference characters designate the same or similar parts throughout the figures of which:

FIG. 1 is a top plan view of a low back pressure belt module having the slotted roller of the present invention installed thereon;

FIG. 2 is a side elevational view of the belt module shown in FIG. 1;

FIG. 3 is an end view of the belt module of FIG. 1;

FIG. 4 is a cross-sectional view taken along lines 4-4 of FIG. 1;

FIG. 5 is a side elevational view of the roller of the present invention; and,

FIG. 6 is a cross-sectional view taken along lines 6-6 of FIG. 5.

### DETAILED DESCRIPTION OF THE INVENTION

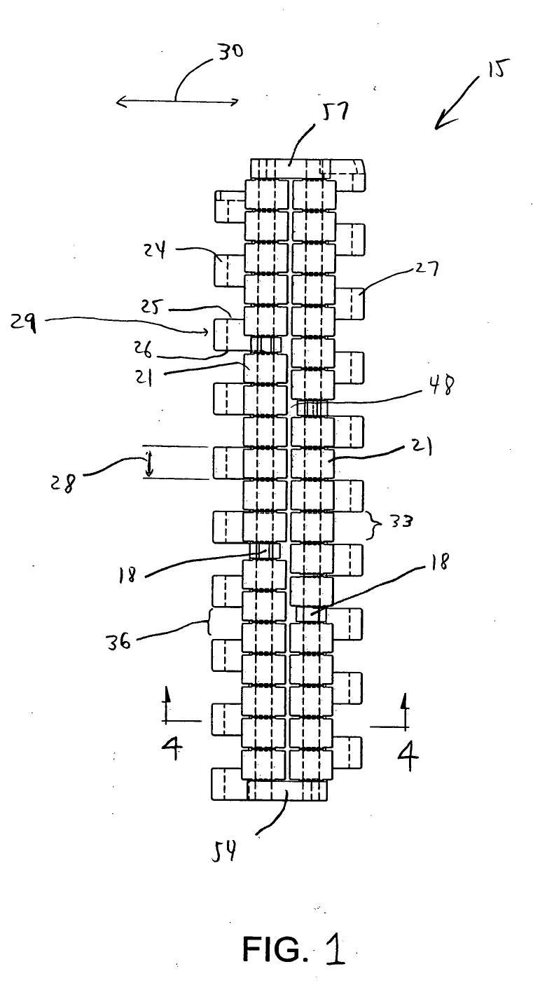

Referring to FIGS. 1-6 generally and initially to FIG. 1, the low back pressure belt module 15 of the present invention includes a pair of shafts 18 supported above the top surface of the module 15. The shafts 18 support a plurality of rollers 21 to provide a low friction conveying surface. The module 15 has a first plurality of link ends 24 and a second plurality of link ends 27 disposed opposite from the first link ends 24. The first plurality of link ends 24 have opposed side walls 25, 26 that provide a transverse thickness 28. The transverse thickness 28 extends in a direction of belt travel 30 from the intermediate section 48 to a first distal portion 29. The second plurality of link ends 27 have similar geometry except they extend opposite to each other in the direction of belt travel indicated by arrow 30. As will be evident to those of ordinary skill in the art based on this disclosure, the belt module 15 may be driven in either direction along arrow 30.

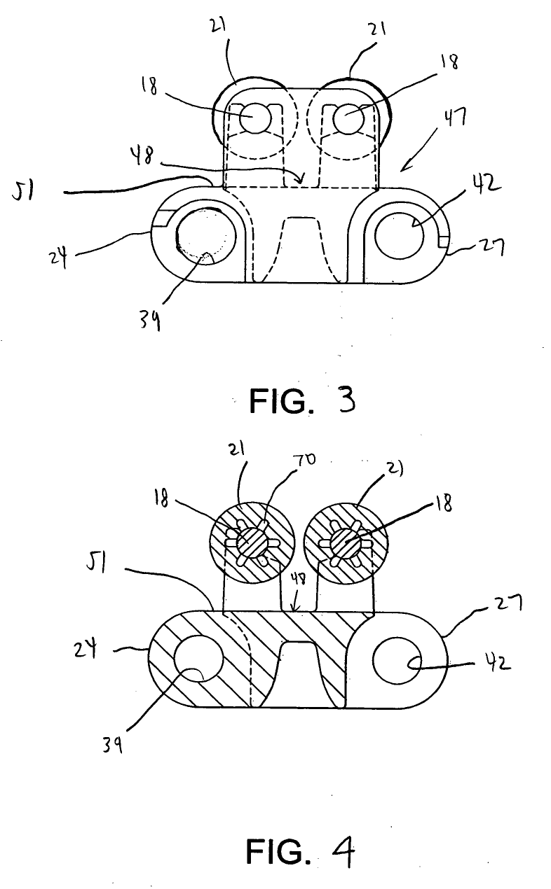

The link ends 24 and 27 are offset in a direction transverse to the direction of belt travel. Accordingly, adjacent modules 15 can be positioned such that the link ends 24 fit in the spaces 33 disposed between link ends 27, and link ends 27 fit in the spaces 36 disposed between link ends 24. The link ends 24, 27 have transverse openings 39 and 42 (FIG. 3) that extend through the transverse thickness 28 between and to the opposed side walls 25, 26. As will be evident to those of ordinary skill in the art, modules 15 can be positioned such that link ends 24 and 27 are intercalated with the link ends 24 and 27 of an adjacent module 15. The side-by-side and intercalated modules 15 can then be connected by pivot rods (not shown) to provide an endless belt capable of articulating about a sprocket to form a conveying system.

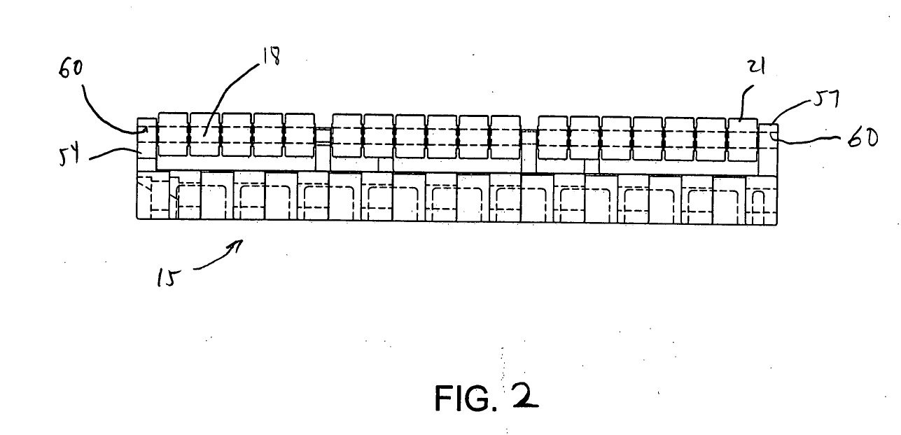

Turning to FIGS. 1-6, module 15 is formed out of plastic or other materials suitable for many applications including conveying of food products. The material should be lightweight, non-corrosive, and easily cleaned. The module 15 is thermoformed from a plastic resin raw material as known to those of ordinary skill in the art. The module 15 has a base portion 47 with an intermediate section 48 extending between first and second link ends 24, 27. Intermediate section 48 has a top surface 51 having a substantially rectangular shape in plan view. At opposite ends of the top surface 51 in a direction transverse to the direction of belt travel, shaft support members 54 and 57 extend upward from the intermediate section 48. The shaft support members 54, 57 have openings 60 (FIG. 2) for receiving and supporting the ends of the shafts 18. The openings 60 comprise a circular bore formed in the shaft support members 54, 57 and are bounded by a curved inner wall having a diameter slightly larger than the diameter of the shaft 18. Each opening 60 supports one of the shafts 18.

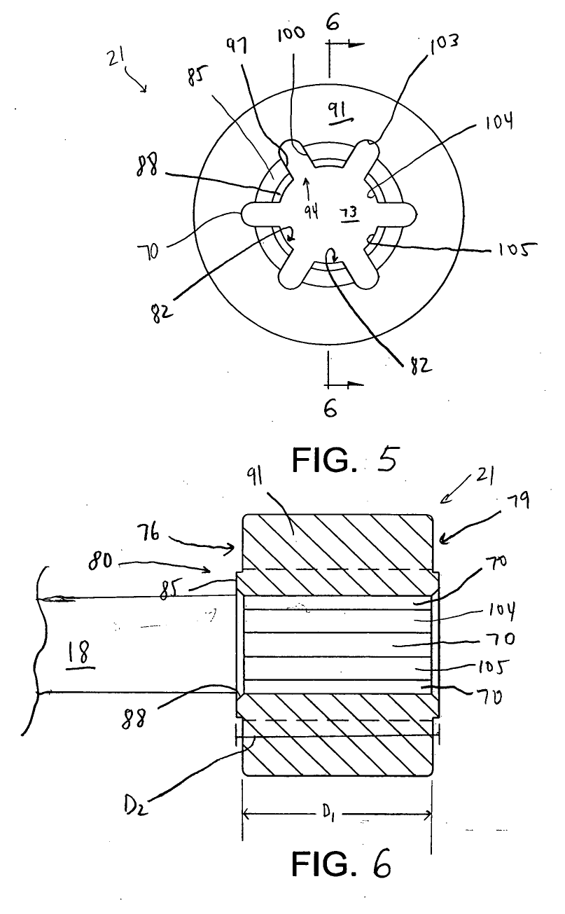

As best shown in FIG. 4, the rollers 21 are supported by the shafts 18 above the top surface of module 15. The rollers 21 form a low pressure conveying surface. The rollers 21 have a plurality of slots 70 that are disposed around the periphery of internal bore 73 (shown in FIG. 5) that receives shaft 18.

Turning to FIG. 5, a plurality of radial slots 70 are disposed approximately equidistantly around the periphery of the internal bore in the roller 21. As shown in FIG. 6, the radial slots 70 extend from a first side 76 of the roller 21 to an opposite second side 79.

The hub 80 of the roller 21 includes an inner wall 82 bordering the internal bore 73. The inner wall 82 is connected to a ring 85 by angled portion 88. The body 91 of the roller 21 has a dimension D₁ that is smaller than the dimension D₂ of the hub 80. As shown in FIG. 5, there are six radial slots 70. The slots 70 have a entry portion 94 that is open to the shaft 18 (FIG. 4). The entry portion 94 leads to a cavity bordered on the sides by internal walls 97 and 100. Internal wall 97 is disposed in spaced apart relation and is approximately parallel to wall 100. Wall 97 is connected to wall 100 by a curved section 103.

Turning to FIG. 6, hubs 80 having an internal bore 73 (FIG. 5) are bordered by surfaces 104, 105 of the inner wall 82. Entry portion 94 provides a path to radial slot 70.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

1. A slotted roller comprising:
a roller body having a rolling contact surface disposed around the periphery thereof, the roller body having a transverse thickness defined between a first sidewall and a second sidewall disposed opposite from the first sidewall, at least one inner wall defining a bore extending through the roller body from the first sidewall to the second sidewall, the bore capable of receiving a shaft, the transverse thickness being less than or equal to the diameter of the roller body;
wherein the roller body is capable of rotating relative to the shaft when the slotted roller is installed on the shaft;
the at least one inner wall having at least one slot defined therein, the at least one slot extending in the roller body away from the shaft when the slotted roller is installed on the shaft.

2. The slotted roller of claim 1, wherein the at least one slot is defined by a pair of side walls connected by an end wall.

3. The slotted roller of claim 1, wherein the at least one slot comprises a plurality of slots.

4. The slotted roller of claim 1, wherein the at least one slot is disposed radially with respect to the center of the shaft.

5. The slotted roller of claim 1, wherein the at least one slot comprises a plurality of slots disposed around the periphery of the bore.

6. The slotted roller of claim 1, wherein the at least one slot extends from the first sidewall to the second side wall.

7. The slotted roller of claim 1, wherein the at least one slot comprises a plurality of slots disposed around the periphery of the bore such that at least two of the slots are disposed in facing relation on opposite sides of the bore.

8. The slotted roller of claim 1 wherein the at least one slot comprises a plurality of slots disposed equidistantly around the periphery of the bore.

9. A belt module, comprising:
an intermediate section having a top surface;
a first plurality of link ends extending from the intermediate section in a first direction, the first plurality of link ends having transverse pivot rod openings;
a second plurality of link ends extending from the intermediate section in a second direction opposite the first direction, the second plurality of link ends having transverse pivot rod openings;
at least one shaft disposed in spaced apart relation to the top surface of the intermediate section;
a plurality of rollers disposed on the at least one shaft, the rollers having a roller body having a rolling contact surface disposed around the periphery thereof, the roller body having a transverse thickness defined between a first sidewall and a second sidewall disposed opposite from the first sidewall, at least one inner wall defining a bore extending through the roller body from the first sidewall to the second sidewall, the bore capable of receiving a shaft, the transverse thickness being less than or equal to the diameter of the roller body;
wherein the roller body is capable of rotating relative to the shaft when the slotted roller is installed on the shaft, the at least one inner wall having at least one slot defined therein, the at least one slot extending in the roller body away from the shaft when the slotted roller is installed on the shaft.

10. The belt module of claim 9, wherein the at least one slot is defined by a pair of side walls connected by an end wall.

11. The belt module of claim 9, wherein the at least one slot comprises a plurality of slots.

12. The belt module of claim 9, wherein the at least one slot is disposed radially with respect to the center of the shaft.

13. The belt module of claim 9, wherein the at least one slot comprises a plurality of slots disposed around the periphery of the bore.

14. The belt module of claim 9, wherein the at least one slot extends from the first sidewall to the second side wall.

15. The belt module of claim 9, wherein the at least one slot comprises a plurality of slots disposed around the periphery of the bore such that at least two of the slots are disposed in facing relation on opposite sides of the bore.

16. The belt module of claim 9 wherein the at least one slot comprises a plurality of slots disposed equidistantly around the periphery of the bore.

17. The slotted roller of claim 2, wherein the side walls forming the slot are disposed parallel to each other.

18. The belt module of claim 10, wherein the side walls forming the slot are disposed parallel to each other.
